(19) United States
(12) Patent Application Publication
(10) Pub. No.: US 2022/0057229 A1
(43) Pub. Date: Feb. 24, 2022

(54) SYSTEM AND METHOD FOR DETERMINING USEFUL GROUND TRUTH DATA

(71) Applicant: HERE Global B.V., Eindhoven (NL)

(72) Inventor: Zhenhua ZHANG, Chicago, IL (US)

(21) Appl. No.: 16/950,545

(22) Filed: Nov. 17, 2020

Related U.S. Application Data
(60) Provisional application No. 63/067,688, filed on Aug. 19, 2020.

(51) Int. Cl. G01C 21/00

(52) U.S. Cl. CPC G01C 21/3819; G01C 21/3837

(57) ABSTRACT

A system, a method, and a computer program product are disclosed for determining useful ground truth data. The system may comprise a memory configured to store computer-executable instructions; and one or more processors configured to execute the instructions to: obtain ground truth data, wherein the ground truth data comprises a plurality of road object observations and a plurality of links such that each road object observation is associated with at least one link from the plurality of links; determine offset data for the ground truth data; determine connectivity data for the ground truth data based on the offset data and a bounded distance threshold; identify one or more useful road segment portions based on the determined connectivity data; and determine the useful ground truth data based on the identified one or more useful road segment portions.

### RELATED APPLICATION

This application claims priority from U.S. Provisional Application Ser. No. 63/067,688, entitled “SYSTEM AND METHOD FOR DETERMINING USEFUL GROUND TRUTH DATA,” filed on Aug. 19, 2020, the contents of which are hereby incorporated herein in their entirety by this reference.

### TECHNOLOGICAL FIELD

The present disclosure generally relates to routing and navigation systems, and more particularly relates to improving accuracy of data for routing and navigation applications.

### BACKGROUND

Currently, various navigation applications are available for vehicle navigation. These navigation applications generally use mapping services, such as those offered by third party service providers like websites, mobile app providers and the like, to request navigation related data. The navigation related data may include data about navigation routes, signs posted on these routes, and the like. Navigation applications or map data thereof based on sensor data associated with road objects are capable to provide up-to-date navigation related data on a requested route. Indeed, the sensor data associated with the road objects should be accurate to accurately provide the up-to-date navigation related data. However, the sensor data associated with road objects may not be accurate As a result, the sensor data associated with the road objects may be evaluated with ground truth data.

### BRIEF SUMMARY OF SOME EXAMPLE EMBODIMENTS

Various embodiments are provided for evaluating the sensor data associated with the road objects using ground truth data. In various embodiments, the ground truth data may be collected by sending human-driven vehicles, also known as ground truth vehicles, to collect data related to road objects on a route. Such data is referred to as the ground truth data and its accuracy is in many cases constrained by human factors, such as considerations of driver's safety, human limitation of working for continuously long hours for ground truth data collection, switching of personnel and vehicle on a day-to-day basis for data collection on long routes and the like. As human drivers cannot work relentlessly for prolonged time durations to collect the ground truth data, the real-time ground truth data collection may be stochastic and incomplete. As a result, the ground truth data thus collected may not be useful to evaluate the sensor data associated with the road objects. To that end, various embodiments are provided for determining useful ground truth data such that the determined useful ground truth data may be used to evaluate the sensor data associated with the road objects. Various embodiments are provided for obtaining ground truth data. In various embodiments, the ground truth data may be incomplete and uncertain ground truth data obtained from one or more ground truth vehicles. As used herein, the ground truth vehicle may be a human-driven vehicle for collecting the ground truth data. In various embodiments, the ground truth data may comprise a plurality of road object observations and a plurality of links such that each road object observation is associated with at least one link from the plurality of links. In various embodiments, the road object observation may comprise a road object and a location associated with the road object. Additionally, the road object observation may comprise timestamp data to indicate a time at which the road object observation was made. In various embodiments, the timestamp data may be associated with the road object. In various embodiments, the road object may comprise a road sign, a road obstacle, a traffic cone, and the like. In various embodiments, the road sign may comprise a speed limit sign, a route guidance sign, a parking sign, a destination sign, a warning sign, and the like. In various embodiments, the road obstacle may comprise a road divider, a road work object and the like.

Various embodiments are provided for determining offset data for the ground truth data. In various embodiments, an offset start location and an offset end location may be determined for each road object observation based on the location associated with each road object observation from a map database for determining the offset data. Various embodiments may be provided determining connectivity data for the ground truth data based on the offset data and a bound distance threshold. In various embodiments, the bounded distance threshold may be a predetermined distance, which is determined based on experiments and the like. In various embodiments, a set of connected links may be extracted from the plurality of links, based on the offset data and the bounded distance threshold for determining the connectivity data. In some embodiments, the timestamp data associated with each road object observation may be determined and the set of connected links may be extracted from the plurality of links, based on the offset data and the bounded distance threshold and the timestamp data for determining the connectivity data.

Various embodiments are provided for identifying one or more useful segments, based on the determined connectivity data. Various embodiments are provided for determining the useful ground truth data based on the identified one or more road segments. For instance, the ground truth data in the identified one or more road segments may be determined as the useful ground truth data. In various embodiments, the useful ground truth data may be optimized ground truth data.

Various embodiments are provided for evaluating sensor data associated the road object, based on the useful ground truth data. In various embodiments, the sensor data associated with the road object may comprise the road object observation collected from a consumer vehicle. As used herein, a consumer vehicle may be a vehicle equipped with sensors for collecting the sensor data. In various embodiments, the sensor data associated with the road object may be compared with the useful ground data to evaluate at least one of an accuracy value, a coverage value, or a combination thereof for the sensor data associated with the road object. To that end, the evaluation process of the sensor data is optimized as the sensor data is evaluated only with the useful ground truth data determined in the one or more road segments rather than evaluating the sensor data by considering the plurality links and the road object observation associated with the plurality of links. Accordingly, performance of a system may be improved when the system executes the embodiments disclosed herein.

In various embodiments, when the determined accuracy value and/or the determined coverage value of the sensor data associated with the road object is above or equal to a threshold value, the sensor data associated with the road object may be used to accurately provide up-to-date navigation functions. Some non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, an accurate road sign information in ramp links, provision of traffic information/data, provision of lane level traffic information/data, vehicle trajectory determination and/or guidance, route and/or maneuver visualization, and/or the like.

A system, a method and a computer program product are provided in accordance with an example embodiment described herein for determining useful ground truth data.

In one aspect, a system for determining useful ground truth data is disclosed. The system may comprise a memory configured to store computer-executable instructions; and one or more processors configured to execute the instructions to: obtain ground truth data, wherein the ground truth data comprises a plurality of road object observations and a plurality of links such that each road object observation is associated with at least one link from the plurality of links; determine offset data for the ground truth data; determine connectivity data for the ground truth data based on the offset data and a bounded distance threshold; identify one or more useful road segment portions based on the determined connectivity data; and determine the useful ground truth data based on the identified one or more useful road segment portions.

According to some embodiments, the one or more processors may be further configured to execute the instructions to evaluate sensor data associated with a road object based on the useful ground truth data.

According to some embodiments, the one or more processors may be further configured to: compare the sensor data associated with the road object with the useful ground truth data; and determine at least one of an accuracy value, a coverage value, or combination thereof for the sensor data associated with the road object, based on the comparison, for evaluating the sensor data associated with the road object.

According to some embodiments, the one or more processors may be further configured to determine an offset start location and an offset end location associated with each road object observation based on a GPS coordinate data associated with the road object observation, for determining the offset data.

According to some embodiments, the one or more processors may be further configured to extract a set of connected links from the plurality of links based on the offset data and the bounded distance threshold, wherein a distance between any two links in the set of connected links is less than or equal to the bounded distance threshold.

According to some embodiments, the one or more processors may be further configured to determine a timestamp data associated with each road object observation from the plurality of road object observations; and extract the set of connected links from the plurality of links based on the offset data, the bounded distance threshold and the timestamp data, for determining the connectivity data.

According to some embodiments, the useful ground truth data may comprise optimized ground truth data collected by one or more ground truth vehicles.

According to some embodiments, the one or more processors may be further configured to execute the instructions to update a map database based on the useful ground truth data.

In another aspect, a method for determining useful ground truth data is disclosed. The method may comprise obtaining ground truth data, wherein the ground truth data comprises a plurality of road object observations and a plurality of links such that each road object observation is associated with at least one link from the plurality of links; determining offset data for the ground truth data; determining connectivity data for the ground truth data based on the offset data and a bounded distance threshold; identifying one or more useful road segment portions based on the determined connectivity data; and determining the useful ground truth data based on the identified one or more useful road segment portions.

According to some embodiments, the method may further comprise evaluating sensor data associated with a road object based on the useful ground truth data.

According to some embodiments, the method may further comprise comparing the sensor data associated with the road object with the useful ground truth data; and determining at least one of an accuracy value, a coverage value, or combination thereof for the sensor data associated with the road object, based on the comparison, for evaluating the sensor data associated with the road object.

According to some embodiments, the method may further comprise determining an offset start location and an offset end location associated with each road object observation based on a GPS coordinate data associated with the road object observation, for determining the offset data for the ground truth data.

According to some embodiments, the method may further comprise extracting a set of connected links from the plurality of links based on the offset data and the bounded distance threshold, wherein a distance between any two links in the set of connected links is less than or equal to the bounded distance threshold, for determining the connectivity data.

According to some embodiments, the method may further comprise determining a timestamp data associated with each road object observation from the plurality of road object observations; and extracting the set of connected links from the plurality of links based on the offset data, the bounded distance threshold and the timestamp data, for determining the connectivity data.

According to some embodiments, the useful ground truth data may comprise optimized ground truth data collected by one or more ground truth vehicles.

According to some embodiments, the method may further comprise updating a map database based on the useful ground truth data.

In yet another aspect, a computer program product comprising a non-transitory computer readable medium having stored thereon computer executable instruction which when executed by one or more processors, cause the one or more processors to carry out operations for determining useful ground truth data, the operations comprising: obtaining ground truth data, wherein the ground truth data comprises a plurality of road object observations and a plurality of links such that each road object observation is associated with at least one link from the plurality of links; determining offset data for the ground truth data; determining connectivity data for the ground truth data based on the offset data and a bounded distance threshold; identifying one or more useful road segment portions based on the determined connectivity data; and determining the useful ground truth data based on the identified one or more useful road segment portions.

According to some embodiments, the operations may further comprise evaluating sensor data associated with a road object based on the useful ground truth data.

According to some embodiments, the operations may further comprise extracting a set of connected links from the plurality of links based on the offset data and the bounded distance threshold, wherein a distance between any two links in the set of connected links is less than or equal to the bounded distance threshold, for determining the connectivity data.

According to some embodiments, the operations may further comprise: determining a timestamp data associated with each road object observation from the plurality of road object observations; and extracting the set of connected links from the plurality of links based on the offset data, the bounded distance threshold and the timestamp data, for determining the connectivity data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and are illustrated by way of example and not by way of limitation, and wherein:

FIG. 1 illustrates a block diagram showing example architecture of a system for determining useful ground truth data, in accordance with one or more example embodiments;

FIG. 2 illustrates a block diagram of the system for determining the useful ground truth data, in accordance with one or more example embodiments;

FIG. 3A illustrates an exemplary route for collecting ground truth data , in accordance with one or more example embodiments;

FIG. 3B illustrates an exemplary ground truth data collected by a ground truth vehicle, in accordance with one or more example embodiments;

FIG. 3C illustrates an exemplary offset data for the ground truth data, in accordance with one or more example embodiments;

FIG. 3D illustrates an exemplary connectivity data for the ground truth data, in accordance with one or more example embodiments;

FIG. 3E illustrates an exemplary scenario for extracting a set of connected links, in accordance with one or more example embodiments;

FIG. 3F illustrates an exemplary useful road segment portions data obtained for the connectivity data, in accordance with one or more example embodiments;

FIG. 4A illustrates an exemplary map tile comprising sensor data associated with road objects, in accordance with one or more example embodiments;

FIG. 4B illustrates an exemplary map tile comprising ground truth vehicle traces of the ground truth vehicle for a route, in accordance with one or more example embodiments;

FIG. 4C illustrates an exemplary map tile comprising useful road segment portions obtained for a route, in accordance with one or more example embodiments;

FIG. 4D illustrates an exemplary map tile comprising useful ground truth data determined in the useful road segment portions, in accordance with one or more example embodiments;

FIG. 5A illustrates a flowchart depicting a method for determining useful ground truth data, in accordance with one or more example embodiments; and

FIG. 5B illustrates a flowchart depicting a method for evaluating sensor data associated with a road object, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements.

Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for determining useful ground truth data. Various embodiments are provided for obtaining ground truth data. In various embodiments, the ground truth data may be incomplete and uncertain ground truth data obtained from one or more ground truth vehicles. As used herein, the ground truth vehicle may be a human- driven vehicle for collecting the ground truth data. In various embodiments, the ground truth data may comprise a plurality of road object observations and a plurality of links such that each road object observation is associated with at least one link from the plurality of links. In various embodiments, the road object observation may comprise a road object and a location associated with the road object. Additionally, the road object observation may comprise timestamp data indicate a time at which the road object observation was made. In various embodiments, the road object may comprise a road sign, a road obstacle, and the like. In various embodiments, the road sign may comprise a speed limit sign, a route guidance sign, a parking sign, a destination sign, a warning sign, and the like. In various embodiments, the road obstacle may comprise a road divider, a road work object and the like.

Various embodiments are provided for determining offset data for the ground truth data. In various embodiments, an offset start location and an offset end location may be determined for each road object observation based on the location associated with each road object observation from a map database for determining the offset data. Various embodiments may be provided determining connectivity data for the ground truth data based on the offset data and a bound distance threshold. In various embodiments, the bounded distance threshold may be a predetermined distance, which is determined based on experiments and the like. In various embodiments, a set of connected links may be extracted from the plurality of links, based on the offset data and the bounded distance threshold for determining the connectivity data. In some embodiments, the timestamp data associated with each road object observation may be determined and the set of connected links may be extracted from the plurality of links, based on the offset data and the bounded distance threshold and the timestamp data for determining the connectivity data.

Various embodiments are provided for identifying one or more useful segments, based on the determined connectivity data. Various embodiments are provided for determining the useful ground truth data based on the identified one or more road segments. For instance, the ground truth data in the identified one or more road segments may be determined as the useful ground truth data. In various embodiments, the useful ground truth data may be optimized ground truth data.

Various embodiments are provided for evaluating sensor data associated the road object, based on the useful ground truth data. In various embodiments, the sensor data associated with the road object may comprise the road object observation collected from a consumer vehicle. As used herein, a consumer vehicle may be a vehicle equipped with sensors for collecting the sensor data. In various embodiments, the sensor data associated with the road object may be compared with the useful ground data to evaluate at least one of an accuracy value, a coverage value, or a combination thereof for the sensor data associated with the road object. To that end, the evaluation process of the sensor data is optimized as the sensor data is evaluated only with the useful ground truth data determined in the one or more road segments rather than evaluating the sensor data by considering the plurality links and the road object observation associated with the plurality of links. Accordingly, performance of a system may be improved when the system executes the embodiments disclosed herein.

In various embodiments, when the determined accuracy value and/or the determined coverage value of the sensor data associated with the road object is above or equal to a threshold value, the sensor data associated with the road object may be used to accurately provide up-to-date navigation functions. Some non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, an accurate road sign information in ramp links, provision of traffic information/data, provision of lane level traffic information/data, vehicle trajectory determination and/or guidance, route and/or maneuver visualization, and/or the like.

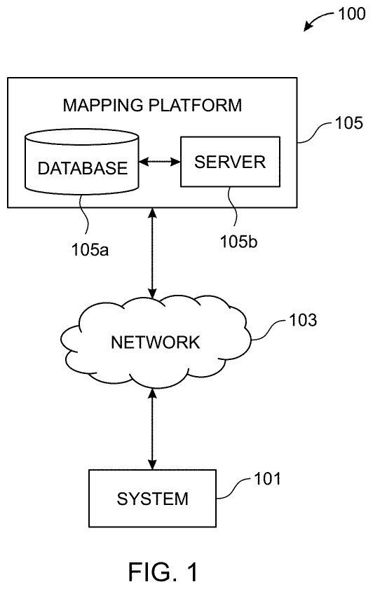

FIG. 1 illustrates a block diagram 100 showing example architecture of a system for determining useful ground truth data, in accordance with one or more example embodiments. As illustrated in FIG. 1, the block diagram 100 may comprise a system 101, a mapping platform 105, and a network 103. The mapping platform 105 may further comprise a map database 105a (also referred as a database 105a) and a server 105b. In various embodiments, the system 101 may be an (Original Equipment Manufacturer) OEM cloud. To that end, the system 101 may be a server (for instance, a backend server, a remotely located server, or the like), group of servers, distributed computing system, and/or other computing system. In some embodiment, the system 101 may be the server 105b of the mapping platform 105 and therefore may be co-located with or within the mapping platform 105. The system 101 may be communicatively coupled with the mapping platform 105 over the network 103.

The network 103 may be wired, wireless, or any combination of wired and wireless communication networks, such as cellular, Wi-Fi, internet, local area networks, or the like. In some embodiments, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The system 101 may communicate with the mapping platform 105, via the network 103, where the mapping platform 105 may comprise the map database 105a for storing map data, and the processing server 105b for carrying out the processing functions associated with the mapping platform 105. The map database 105a may store node data, road segment data or link data, point of interest (POI) data, posted signs related data, such as road sign data or the like. The map database 105a may also include cartographic data and/or routing data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road/link data and the node data may represent a road network, such as used by vehicles, for example, cars, trucks, buses, motorcycles, and/or other entities.

Optionally, the map database 105a may contain path segment and node data records or other data that may represent pedestrian paths or areas in addition to or instead of the vehicle road record data, for example. The road/link segments and nodes may be associated with attributes, such as geographic coordinates, street names, address ranges, lane level speed profile (historically derived speed limits for a lane), lane level maneuver pattern (lane change patterns at intersections), and other navigation related attributes, as well as POIs, such as fueling stations, hotels, restaurants, museums, stadiums, offices, auto repair shops, buildings, stores, parks, etc. The map database 105a may include data about the POIs and their respective locations in the POI records. The map database 105a may additionally include data about places, such as cities, towns, or other communities, and other geographic features such as bodies of water, mountain ranges, etc. Such place or feature data may be part of the POI data or may be associated with POIs or POI data records (such as a data point used for displaying or representing a position of a city). In addition, the map database 105a may include event data (e.g., traffic incidents, construction activities, scheduled events, unscheduled events, etc.) associated with the POI data records or other records of the map database 105a. The map database 105a may additionally include data related to road signs. The map database may be communicatively coupled to the processing server 105b.

The processing server 105b may comprise processing means and communication means. For example, the processing means may comprise one or more processors configured to process requests received from the system 101. The processing means may fetch map data from the map database 105a and transmit the same to the system 101 in a format suitable for use by the system 101. In some example embodiments, as disclosed in conjunction with the various embodiments disclosed herein, the system 101 may be used to determine useful ground truth data.

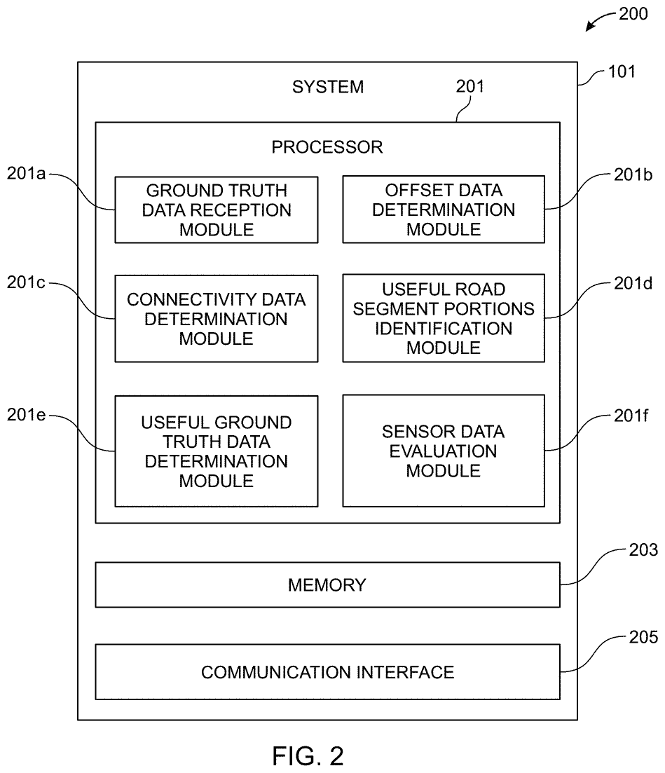

FIG. 2 illustrates a block diagram 200 of the system 101 for determining the useful ground truth data, in accordance with one or more example embodiments of the present invention. The system 101 may include a processing means such as at least one processor 201, storage means such as a memory 203, and a communication means such as at least one communication interface 205. Further, the system 101 may comprise a ground truth data reception module 201a, an offset data determination module 201b, a connectivity data determination module 201c, a useful road segment portions identification module 201d, a useful ground truth data determination module 201e, and a sensor data evaluation module 201f. In various embodiments, the ground truth data reception module 201a may be configured to obtain ground truth data. In various embodiments, the offset data determination module 201b may be configured to determine offset data for the ground truth data obtained by the ground truth data reception module 201a. In various embodiments, the connectivity data determination module 201c may be configured to determine connectivity data for the ground truth data obtained by the ground truth data reception module 201a. In various embodiments, the useful road segment portions identification module 201d may be configured to identify one or more useful road segment portions based on the connectivity data determined by the connectivity data determination module 201c. In various embodiments, the useful ground truth data determination module 201e may be configured to determine the useful ground truth data based on the useful road segment portions identified by the useful road segment portions identification module 201d. In various embodiments, the sensor data evaluation module 201f may be configured to evaluate sensor data associated with a road object based on the useful ground truth data determined by the useful ground truth data determination module 201e. According to some embodiments, each of the modules 201a, 201b, 201c, 201d, 201e, and 201f may be embodied in the processor 201. The processor 201 may retrieve computer program code instructions that may be stored in the memory 203 for execution of computer program code instructions, which may be configured for determining the useful ground truth data.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

Additionally or alternatively, the processor 201 may include one or more processors capable of processing large volumes of workloads and operations to provide support for big data analysis. In an example embodiment, the processor 201 may be in communication with a memory 203 via a bus for passing information among components of structure 100. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system 101 to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to users of the system 101, where the users may be a traveler, a rider, a pedestrian, a driver of the vehicle and the like. In some embodiments, the users may be or correspond to an autonomous or semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101. For example, the communication interface may comprise I/O interface which may be in the form of a GUI, a touch interface, a voice enabled interface, a keypad and the like. For example, the communication interface may be a touch enabled interface of a navigation device installed in a vehicle, which may also display various navigation related data to the user of the vehicle. Such navigation related data may include information about upcoming conditions on a route, route display, alerts about vehicle speed, user assistance while driving and the like.

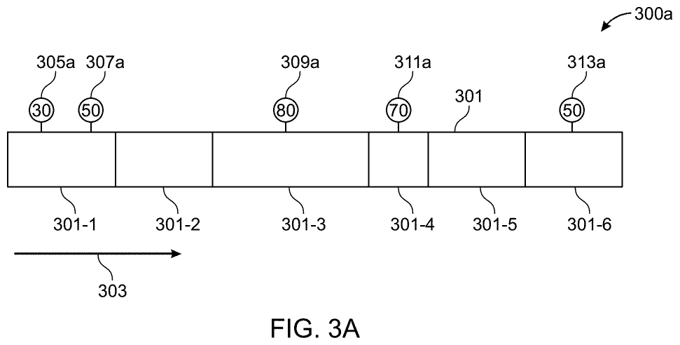

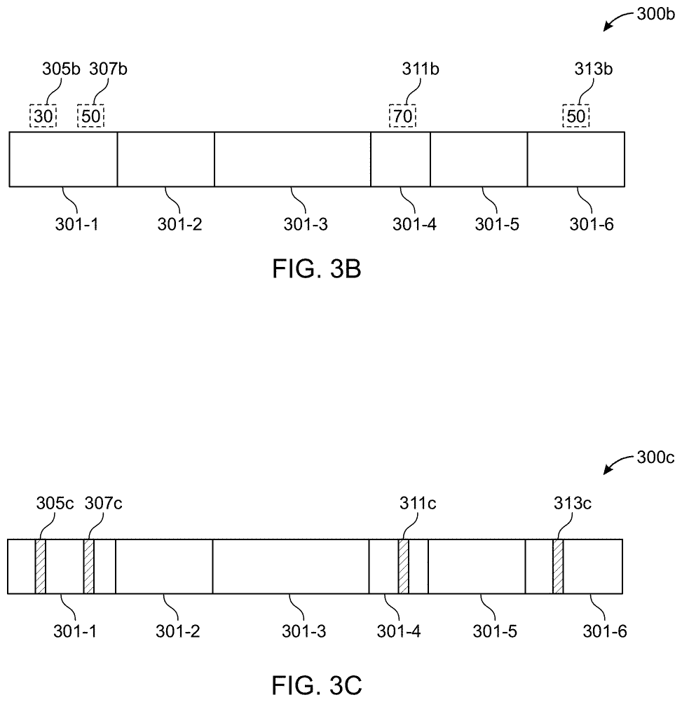

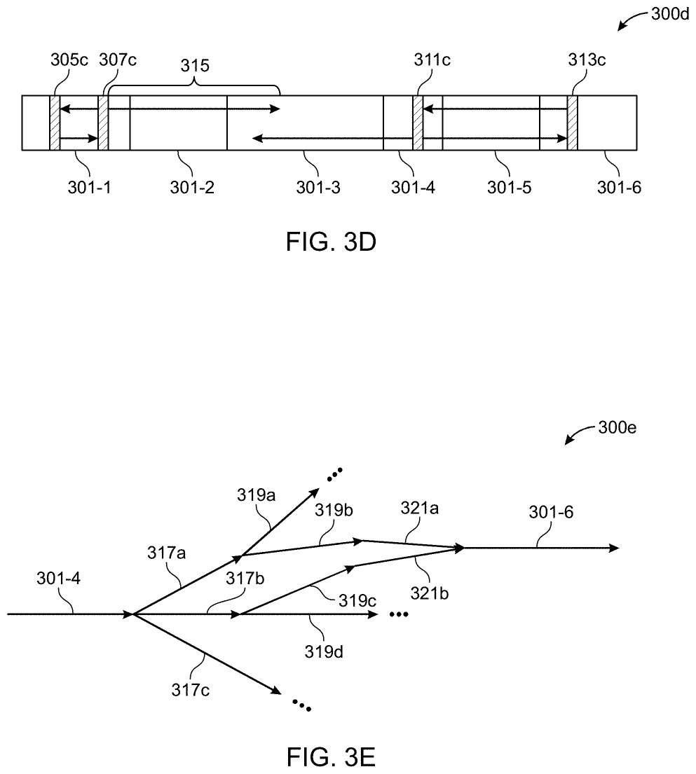

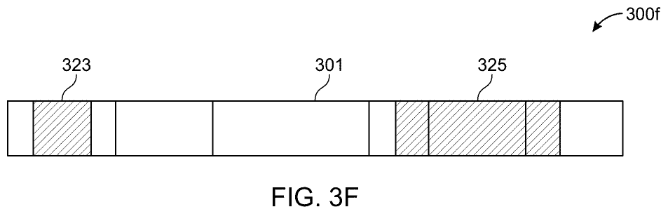

FIG. 3A illustrates an exemplary scenario 300a for collecting ground truth data and collecting sensor data, in accordance to one or more example embodiments. As illustrated in FIG. 3A, the scenario 300a may comprise a route 301 and a travel direction 303 associated with the route 301. In various embodiments, the route 301 may comprise a plurality of links such as a link 301-1, a link 301-2, a link 301-3, a link 301-4, a link 301-5 and a link 301-6 between a start location (also referred as a start node) of the route 301 and an end location (also referred as an end node) of the route 301. In various embodiments, the plurality of links 301-1, 301-2, 301-3, 301-4, 301-5, and 301-6, may be obtained by dividing the route 301 into small sub-routes such that each sub-route is referred to as a “link” for the purpose of explanation of various embodiments of the present invention. Thus the link 301-1, the link 301-2, the link 301-3, the link 301-4, the link 301-5 and the link 301-6 are all sub-routes on the route 301 and the route 301 may be a road segment between two nodes such as the start node and the end node. In various embodiments, the start node and the end node for the route 301 may be interchangeable with respect to the travel direction 303. Here for purpose of explanation, the route 301 comprising six links (i.e. 301-1 to 301-6) is considered, however, the route 301 may be divided into a finite number of links without deviating from the scope of the invention. Further, each of the plurality of links 301-1 to 301-6 may or may not comprise one or more road objects. In other words, the route 301 comprises a plurality of links 301-1-301-6 on which a plurality of road objects 305a, 307a, 309a, 311a, and 313a may be randomly (or uncertainly) located as illustrated in FIG. 3A. According to some other embodiments, the system 101 may divide the route 301 into the plurality of links 301-1, 301-2, 301-3, 301-4, 301-5, and 301-6, when one or more road objects (305a, 307a, 309a, 311a, and 313a) of the plurality of road objects 305a, 307a, 309a, 311a, and 313a is located at a greater distance than a bounded distance threshold from each other road object of the plurality of road objects 305a, 307a, 309a, 311a, and 313a. In various embodiments, the bounded distance threshold may be a predetermined distance, which is determined by experimentation and the like. Here for purpose of explanation, the plurality of road objects 305a, 307a, 309a, 311a, and 313a are considered as speed limit signs posted on the route 301, however, the plurality of road objects 305a, 307a, 309a, 311a, and 313a may include road signs posted on the route 301, road obstacles on the route 301, traffic objects on the route, such as traffic cones, guide rails and the like. In various embodiments, the road signs may include speed limit signs, route guidance signs, parking signs, destination signs, warning signs, and the like. In various embodiments, the road obstacles may comprise road dividers, road work objects and the like. In some example embodiments, the plurality of road objects 305a, 307a, 309a, 311a, and 313a may include a combination of the road signs and/or a combination of the road obstacles. In some embodiments, the techniques discussed within this disclosure may also be applicable to objects other than road objects, such as for objects detected on a water route, air route and the like.

In various embodiments, the travel direction 303 associated with route 301 may indicate a direction of travel for evaluating the ground truth data and in many cases, this direction of travel may be described as a direction of travel of a vehicle. For instance, the travel direction 303 may indicate a direction of travel of a consumer vehicle for collecting sensor data associated with the plurality of road objects 305a, 307a, 309a, 311a, and 313a and/or a direction of travel of a ground truth vehicle for collecting ground truth data for the plurality of road objects 305a, 307a, 309a, 311a, and 313a. As used herein, the consumer vehicle may correspond to a vehicle equipped with sensor such as a camera sensor, a LIDAR sensor and/or a RADAR sensor for collecting sensor data associated with the plurality of road objects 305a, 307a, 309a, 311a, and 313a. In some embodiments, the sensor data associated with the road object may comprise a road object observation for the road object. In some embodiments, the road object observation may comprise a road object and a location (Global Positioning System (GPS) coordinate data) associated with the road object. Additionally, the road object observation may comprise timestamp data indicating a time (also includes date, month and year) at which the road object observation was made. In various embodiments, the consumer vehicle may be an autonomous vehicle, a semiautonomous vehicle, or a manual vehicle. As used herein, the ground truth vehicle may correspond to a human-driven vehicle for collecting the ground truth data for the plurality of road objects 305a, 307a, 309a, 311a, and 313a. Further, an exemplary ground truth data collected by the ground truth vehicle is explained in the detailed description of FIG. 3B.

FIG. 3B illustrates an exemplary ground truth data 300b collected by the ground truth vehicle, in accordance to one or more example embodiments. As illustrated in FIG. 3B, the ground truth data 300b may comprise a plurality of road object observations 305b, 307b, 311b, and 313b and a plurality of links 301-1, 301-2, 301-3, 301-4, 301-5, and 301-6. In various embodiments, each of the plurality of road object observations 305b, 307b, 311b, and 313b may comprise the road object and a location (Global Positioning System (GPS) coordinate data) associated with the road object. Additionally, each of the plurality of road object observations 305b, 307b, 311b, and 313b may comprise timestamp data indicating a time (also includes date, month and year) at which the road object observation was made. In various embodiments, each of the plurality of road object observations 305b, 307b, 311b, and 313b may be associated with at least one link of the plurality of links 301-1, 301-2, 301-3, 301-4, 301-5, and 301-6 as illustrated in FIG. 3B. In various embodiments, the plurality of road object observations 305b, 307b, 311b, and 313b may be associated with the plurality of links 301-1, 301-2, 301-3, 301-4, 301-5, and 301-6 based on the GPS coordinate data associated with each of the plurality of road object observations 305b, 307b, 311b, and 313b. For instance, the road object observation 305b indicating a speed limit sign with a speed limit value of 30 km/h (mph) may be associated with the link 301-1 as a location (i.e. the GPS coordinate data) of the road object 305a (i.e. the speed limit sign 305a) is on the link 301-1. Similarly, the road object observation 307b, the road object observation 311b, the road object observation 313b may associated with the link 301-1, the link 301-4, and the link 301-6 respectively. To that end, the ground truth data 300b may comprise a plurality of links 301-1, 301-2, 301-3, 301-4, 301-5, and 301-6 on which the plurality of road observations 305b, 307b, 311b, and 313b may be randomly (uncertainly) located. According to some embodiments, a road object observation corresponding to the road object 309a may not be recorded while collecting the collecting the ground truth data 300b due to any of the limitations, such as human error, discussed earlier. As a result, the ground truth data 300b may be incomplete and uncertain ground truth data. Hereinafter, ‘the ground truth data 300b’ and ‘incomplete and uncertain ground truth data’ may be interchangeably used to mean the same. In various embodiments, the system 101 may be configured to obtain the ground truth data 300b. For instance, the ground truth data reception module 201a may be configured to obtain the ground truth data 300b. In some example embodiments, the system 101 may obtain the ground truth data 300b from the one or more ground truth vehicles. Further, the system 101 may be configured to determine offset data for the ground truth data 300b as explained in the detailed description of FIG. 3C.

FIG. 3C illustrates an exemplary offset data 300c for the ground truth data 300b, in accordance to one or more example embodiments. In various embodiments, the system 101 may be configured to determine the offset data 300c for the ground truth data 300b. For instance, the offset data determination module 201b may be configured to determine offset data 300c for the ground truth data 300b. In various embodiments, the system 101 may convert the location (the GPS coordinate data) associated with each of the plurality of road object observations 305b, 307b, 311b, and 313b, which is a point based data, as the GPS coordinate is a point observation, into line data format for determining the offset data 300b. For instance, the system 101 may convert positions (i.e. the GPS coordinate data) associated with the plurality of road object observations 305b, 307b, 311b and 313b into lines (i.e. the line data) on the link 301-1, the link 301-1, the link 301-4, and the link 301-6 respectively. In some embodiments, the system 101 may determine an offset start location and an offset end location for the line data associated with each of the plurality of road object observations 305b, 307b, 311b and 313b. In some example embodiments, the offset start location and offset end location for a road object observation may be determined from the mapping platform 105. In various embodiments, the system 101 may determine a portion of the link 301-1 covered between the offset start location and the offset end location associated with the road object observation 305b as offset data 305c for the road object observation 305b. Similarly, the system 101 may determine offset data 307c, offset data 311c and offset data 313c for the road object observation 307b, the road object observation 311b, and the road object observation 313b respectively. The offset data 305c-313c in the line data format is used to identify offset in the position of the road object observations, which may be defined in terms of a ratio or a percentage, which is caused at the time of receiving the road object observations 305b-313b. For example, the actual position of the road object observation 305b may be detected by various ground truth vehicles within 30 to 40 percent offset or 30 to 40 percent distance deviation from the actual position. Thus, when such multiple observations from multiple ground truth vehicles are combined, the entire range of point based deviations may be converted into a line based offset data 305c.

To that end, the system 101 may determine offset data 305c, offset data 307c, offset data 311c and offset data 313c for the plurality of road object observations 305b, 307b, 311b, and 313b respectively. In various embodiments, each of the offset data (305c, 307c, 311c and 313c) may indicate a relativity of the corresponding road object observation (305b, 307b, 311b, and 313c) on the corresponding link (301-1, 301-4, and 301-6). In some example embodiments, the system 101 may determine the offset data (305c, 307c, 311c and 313c) as a percentage on the corresponding link (305c, 307c, 311c and 313c). In some example embodiments, when the link (305c, 307c, 311c and 313c) comprises more than one offset data (305c, 307c, 311c and 313c), the system 101 may determine a minimum offset data and a maximum offset data. For instance, the system 101 may determine the offset data 305c as the minimum offset data and the offset data 307c as the maximum offset data for the link 301-1, since the link 301-1 comprises two offset data (i.e. the offset data 305c and the offset data 307c). In this way, the system 101 may determine the offset data 300c for the ground truth data 300b. Further, the system 101 may be configured to determine connectivity data for the ground truth data 300b as explained in the detailed description of FIG. 3D.

FIG. 3D illustrates an exemplary connectivity data 300d for the ground truth data 300b, in accordance to one or more example embodiments. In various embodiments, the system 101 may be configured to determine the connectivity data 300d for the ground truth data 300b, based on the offset data 300c and a bounded distance threshold 315. For instance, the connectivity data determination module 201c may be configured to determine the connectivity data 300d for the ground truth data 300b, based on the offset data 300c and the bounded distance threshold 315. In various embodiments, the bounded distance threshold 315 may be a predetermined distance. In some example embodiments, the bounded distance threshold 315 may be determined by experimentation and the like.

Once the offset data 300c is determined, the system 101 may determine at least one link from the plurality of links 301-1, 301-2, 301-3, 301-4, 301-5, and 301-6 that comprises more than one offset data (305c, 307c, 311c, and 313c). For instance, the system 101 may determine the link 301-1 from the plurality of links 301-1, 301-2, 301-3, 301-4, 301-5 and 301-6, as the link 301-1 comprises the offset data 305c and the offset data 307c. In response to determining the at least one link (i.e. the link 301-1) from the plurality of links 301-1, 301-2, 301-3, 301-4, 301-5, and 301-6, the system 101 may determine whether any offset data (305c, 307c, 311c, and 313c) is within the bounded distance threshold 315 from the offset data 305c and from the offset data 307c, using a search algorithm, such as a greedy search algorithm. In various embodiments, the greedy search algorithm may execute an upstream search and a downstream search from the offset data 305c and from the offset data 307c to determine whether any offset data (305c, 307c, 311c, and 313c) is within the bounded distance threshold 315 from the offset data 305c and from the offset data 307c. As the offset data 307c is within the bounded distance threshold 315 from the offset data 305c and the offset data 305c is within the bounded distance threshold 315 from the offset data 307c, the system 101 may be configured to determine a portion of the link 301-1 between the offset data 305c and the offset data 307c as connectivity data for the offset data 305c and offset data 307c.

Further, the system 101 may determine one or more links from the plurality of links 301-1, 301-2, 301-3, 301-4, 301-5, and 301-6 that comprises only one offset data (305c, 307c, 311c, and 313c). For instance, the system 101 may determine the link 301-4 and the link 301-6 from the plurality of links 301-1, 301-2, 301-3, 301-4, 301-5, and 301-6, as the link 301-4 comprises the offset data 311c and the link 301-6 comprises the offset data 313c. In response to determining the link 301-4 and the link 301-6 from the plurality of links 301-1, 301-2, 301-3, 301-4, 301-5, and 301-6, the system 101 may determine whether any offset data (305c, 307c, 311c, and 313c) is within the bounded distance threshold 315 from the offset set data 311c and from the offset data 313c, using the greedy search algorithm.

In various embodiments, the greedy search algorithm may perform the upstream search from the offset data 311c for determining whether any offset data (305c, 307c, 311c, and 313c) is within the bounded distance threshold 315 from the offset set data 311c. For instance, the greedy search algorithm may traverse along the link 301-5 and the link 301-6 for determining whether any offset data (305c, 307c, 311c, and 313c) is within the bounded distance threshold 315 from the offset set data 311c. Further, the greedy search algorithm may perform the downstream search from the offset data 311c for determining whether any offset data (305c, 307c, 311c, and 313c) is within the bounded distance threshold 315 from the offset set data 311c. For instance, the greedy search algorithm may traverse along the link 301-3 for determining whether any offset data (305c, 307c, 311c, and 313c) is within the bounded distance threshold 315 from the offset set data 311c. Similarly, the greedy search algorithm may perform the upstream search and the downstream search from the offset data 313c for determining whether any offset data (305c, 307c, 311c, and 313c) is within the bounded distance threshold 315 from the offset set data 313c. In response to determining the offset data 313c is within the bounded distance threshold 315 from the offset data 311c and the offset data 311c is within the bounded distance threshold 315 from the offset data 313c, the system 101 may be configured to extract a set of connected links from the plurality of links 301-1, 301-2, 301-3, 301-4, 301-5, and 301-6 between the link 301-4 corresponding to the offset data 311c and the link 301-6 corresponding to the offset data 313c. In various embodiments, a distance between any two links in the set of connected links is less than or equal to the bounded distance threshold 315. In some example embodiments, the system 101 may extract the link 301-5 as a connected link, if a distance from the offset data 311c to the offset data 313c via the link 301-5 is within the bounded distance threshold 315. In various embodiments, the extracted set of connected links may be the connectivity data for the offset data 311c and for the offset data 313c. For instance, the link 301-5 may be the connectivity data for the offset data 311c and for the offset data 313c, if the distance from the offset data 311c to the offset data 313c via the link 301-5 is within the bounded distance threshold 315. Further, the system 101 may extract the set of connected links as explained in the detailed description of FIG. 3E.

FIG. 3E illustrates an exemplary scenario 300e for extracting the set of connected links, in accordance to one or more example embodiments. As illustrated in FIG. 3E, the scenario 300e may comprise a plurality of links between the link 301-4 and the link 301-6. In various embodiments, the system 101 (comprising the greedy search algorithm) may perform the upstream search through each of links 317a, 317b, 317c, 319a, 319b, 319c, 319d, 321a, and 321b to determine whether any offset data (305c, 307c, 311c, and 313c) is within the bounded distance threshold 315 from the offset data 311c of the link 301-4. If the system 101 determines the offset data 313c of the link 301-6 is within the bounded distance threshold 315 from the offset data 311c of the link 301-4 via the link 317a, the link 319b, and the link 321a, the system 101 may extract the link 317a, the link 319b, and the link 321a as the set of connected links for the offset data 311c of the link 301-4. If the system 101 determines the offset data 313c of the link 301-6 is within the bounded distance threshold 315 from the offset data 311c of the link 301-4 via the link 317b, the link 319c, and the link 321b, the system 101 may extract the link 317b, the link 319c, and the link 321b as the set of connected links for the offset data 311c of the link 301-4.

Additionally, the system 101 may determine the timestamp data associated with each of the road object observations of the link 301-4 and the link 301-6. For instance, the system 101 may determine the timestamp data associated with the road object observation 311b and the road object observation 313b. To that end, the system 101 may extract the set of connected links from the plurality links 301-1, 301-2, 301-3, 301-4, 301-5, and 301-6, based on the offset data 300c, the bounded distance threshold 315 and the timestamp data. Hereinafter, ‘the set of connected links’ and ‘candidate route’ may be interchangeably used to mean the same. In some example embodiments, if both a first candidate route via the link 317a, the link 319b, and the link 321a, and a second candidate route via the link 317b, the link 319c, and the link 321b are within the bounded distance threshold 315, the system 101 may determine a timestamp difference between the timestamp data associated with the road object observation 311b and the timestamp data associated with the road object observation 311b. Further, the system 101 may determine, using the timestamp difference, a viable candidate route among the first candidate route and the second candidate route such that an on-route distance of the viable candidate route divided by the timestamp difference matches a speed limit range. For instance, the system 101 may determine an on-route distance for the first candidate route (i.e. a distance from a start location of the link 317a to an end location of the link 321a via the link 317a, the link 319b and the link 321a); determine an on-route distance for the second candidate route; divide the on-route distance of the first candidate route and the on-route distance of the second candidate route by the timestamp difference; and determine, using the speed limit range, the viable candidate route among the first candidate route and the second candidate route, based on the on-route distance divided by the timestamp difference of the first candidate route and the on-route distance divided by the timestamp difference of the second candidate route. In various embodiments, the speed limit range may be predetermined range of speed limit values, for instance, thirty to forty (30-40) kmph. In some example embodiments, the viable candidate route may be the connectivity data for the offset data 311c and the offset data 313c. To that end, the system 101 may eliminate the set of connected links (either the first candidate route or the second candidate route) on which the ground truth vehicle have travelled with a faster speed or a slower speed in comparison to the speed limit range. Accordingly, the system 101 may extract reliable set of connected links, based on the offset data 300c, the bounded distance threshold 315, and the time stamp data. In this way, the system 101 may determine the connectivity data 300d for the ground truth data 300b. Further, the system 101 may be configured to identify one or more useful road segment portions for the connectivity data 300d as explained in the detailed descriptions of FIG. 3F.

FIG. 3F illustrates an exemplary useful road segment portions 300f for the connectivity data 300d, in accordance to one or more example embodiments. In various embodiments, the system 101 may be configured to identify one or more useful road segment portions 323 and 325, based on the determined connectivity data 300d. For instance, the useful road segment portions identification module 201d may be configured to identify the one or more useful road segment portions 323 and 325, based on the determined connectivity data 300d. In various embodiments, the system 101 may identify the offset data 305c, the offset data 307c and the portion of the link 301-1 between the offset data 305c and the offset data 307c as the useful road segment portion 323. To that end, a length of the useful road segment portion 323 may include a length of the offset data 305c, a length of the offset data 307c and a length of the portion of the link 301-1 between the offset data 305c and the offset data 307c. Similarly, the system 101 may identify the offset data 311c, the offset data 313c, and a portion of the route 301 between the offset data 313c and the offset data 313c as the useful road segment portion 325. To that end, a length of the useful road segment portion 325 may include a length of the offset data 311c, a length of the offset data 313c and a length of the portion of the route 301 between the offset data 305c and the offset data 307c.

Further, the system 101 may be configured to determine useful ground truth data, based on the identified one or more useful road segment portions 323 and 325. For instance, the useful ground truth data determination module 201e may be configured to determine the useful ground truth data, based on the identified one or more useful road segment portions 323 and 325. In various embodiments, the system 101 may extract optimized ground truth data collected by the one or more ground truth vehicles in the one or more useful road segment portions 323 and 325 as the useful ground truth data. To that end, the useful ground truth data may comprise the optimized ground truth data collected by the one or more ground truth vehicles. In some embodiments, the system 101 may update the map database 105a with the useful ground truth data. In some example embodiments, the map database 105a may store the useful ground truth data as updated ground truth data for the route 301.

In various embodiments, the system 101 may be configured to evaluate the sensor data associated with the one or more road objects (305a-313a), based on the useful ground truth data. For instance, the sensor data evaluation module 201f may be configured to evaluate the sensor data collected on the route 301 from the consumer vehicles, based on the useful ground truth data. In various embodiments, the system 101 may compare the sensor data associated with the one or more road objects (305a-313a) with the useful ground truth data for evaluating the sensor data associated with the one or more road objects (305a-313a). Further, in some embodiments, the system 101 may determine at least one of an accuracy value, a coverage value, or a combination thereof for the sensor data associated with the one or more road objects (305a-313a), based on the comparison. In some example embodiments, the system 101 may update the map database 105a with the at least one of the accuracy value, the coverage value, or a combination thereof of the sensor data associated with the one or more road objects (305a-313a) to determine a reliability value for the sensor data associated with the one or more road objects (305a-313a).

In some example embodiments, the useful ground truth data may be used to evaluate the sensor data provided by a third party service provider to the mapping platform 105. To that end, the mapping platform 105 may evaluate the accuracy of the sensor data of the third-party service provider based on only the useful ground truth data between useful road segment portions 323 and 325 and output an accuracy value, such as percentage, to the third-part service provider indicating how accurate their sensor data is.

In some related example embodiments, the useful ground truth data may be used to perform on-the-fly validation for sensor data received directly from one or more vehicles, such as in machine learning applications based on a machine learning model, which may be further based on useful ground truth data.

In some other example embodiments, the useful ground truth data may be used for increasing the accuracy of all the mapping and navigation related algorithms provided by the mapping platform 105. These algorithms may include, but are not limited to machine learning algorithms, deep learning algorithms, artificial intelligence algorithms, road sign evaluation products, and the like.

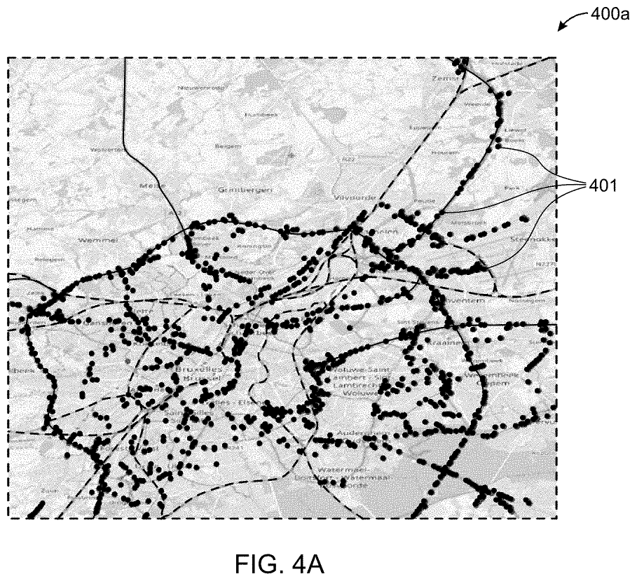

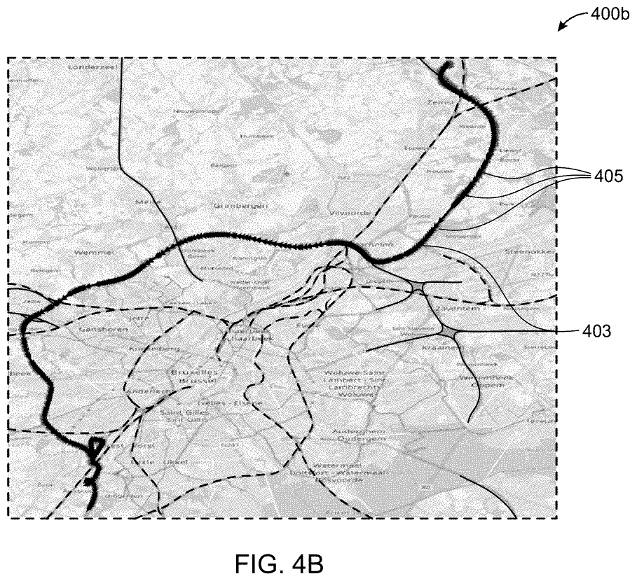

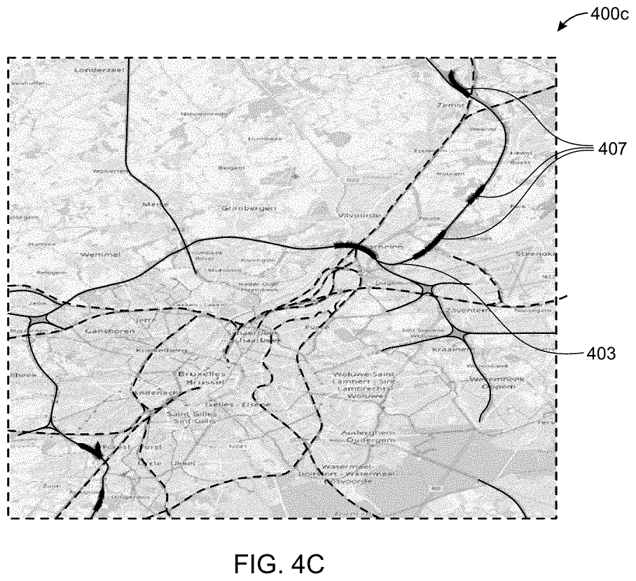

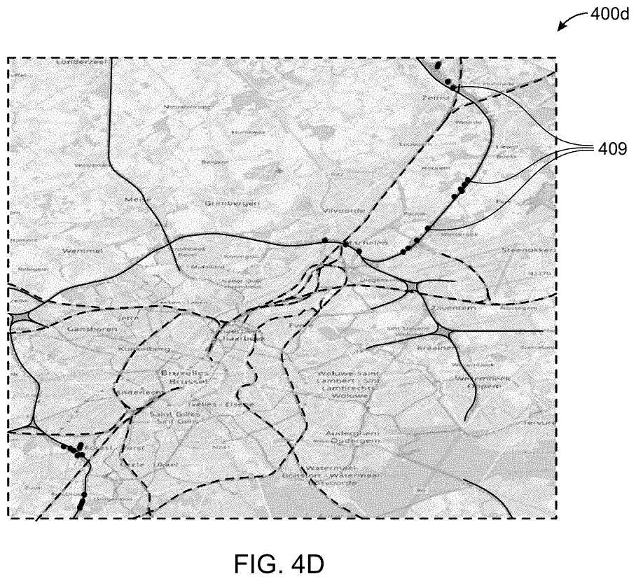

In some example embodiments, the system 101 may determine the reliability value for the sensor data associated with the one or more road objects (305a-313a), based on the accuracy value and/or the coverage value of the sensor data associated with the one or more road objects (305a-313a). Further, the system 101 may accurately provide up-to-date navigation functions for the consumer vehicles, when the reliability value of the sensor data is above or equal to a threshold reliability value. Some non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, an accurate road sign information in ramp links, provision of traffic information/data, provision of lane level traffic information/data, vehicle trajectory determination and/or guidance, route and/or maneuver visualization, and/or the like. Furthermore, according to some example embodiments, the system 101 may evaluate the sensor data associated with the road objects of a map tile or a map region as explained in the detailed description of FIG. 4A-4D.

FIG. 4A illustrates an exemplary map tile 400 comprising the sensor data associated with the road objects, in accordance to one or more example embodiments. In various embodiments, the mapping platform 105 may store a digital map in the map database 105a. In various embodiments, the digital map may comprise map data of the world. The map data of the world may correspond to satellite raster imagery, bitmap imagery, or the like. In various embodiments, the satellite rater imagery/bitmap imagery may include map features and attribute data corresponding to the map features. In some embodiments, the map features may have a vector representation form. In an alternate embodiment, the digital map may comprise 3D map data of the world. In various embodiments, the 3D map data corresponds to 3D map features, which are defined as vectors, voxels, or the like.

In various embodiments, the mapping platform 105 may store the digital map (i.e., the map data and/or the 3D map data) in multiple levels of granularity. In various embodiments, the multiple levels of granularity may indicate a zeroth (0^{th}) level of granularity of the digital map to n^{th} level of granularity of the digital map. In an embodiment, n is a positive integer. In some embodiments, the level of granularity may be based on a resolution value of the digital map. In various embodiments, the zeroth level of granularity of the digital map may cover the map data of the world. As the map data of the world is huge to process, the zeroth level of granularity of the digital map may be divided into equal small sized map tiles or map areas to obtain the n^{th} level of granularity of the digital map. For the 3D digital map, the zeroth level of granularity of the 3D digital map may be divided into equal small sized map cubes or map volumes to obtain the n^{th} level of granularity of the 3D digital map. In various embodiments, the n^{th} level of granularity may be determined based on an application need. For example, 12^{th} level of granularity of the digital map may be utilized for applications such as automotive road maps in formats such as NDS (Navigation Data Standard).

Here of purpose of explanation, the map tile 400a of the equal small sized map tiles of nth level of granularity of the digital map is considered. In various embodiments, the map tile 400a may comprise the sensor data 401 associated with the road objects for a region. In various embodiments, the sensor data 401 associated with the road object may comprise the road object observation for the road object. In various embodiments, the road object observation may comprise the road object and the location (Global Positioning System (GPS) coordinate data) associated with the road object. Additionally, the road object observation may comprise timestamp data indicating a time (also includes date, month and year) at which the road object observation was made. In various embodiments, the sensor data 401 may be collected from the sensors of the consumer vehicles. To that end, the sensor data 401 may be inaccurate, as the sensors report road objects/road signs posted on moving vehicles on buildings or the like as the road object observation. Accordingly, the sensor data 401 may need to be evaluated to determine the accuracy value and/or the coverage value of the sensor data 401. For evaluating the sensor data 401, the ground truth data for the map tile 400a may need to be collected. The ground truth data may be collected by sending the human driver-cars (i.e. the one or more ground truth vehicles) on route basis to collect the road object observations (305b-313b). For instance, the one or more ground truth vehicles may be sent to a plurality of routes in the map tile 400a for collecting the ground truth data. Further, ground truth vehicle traces of the ground truth vehicle while collecting the ground truth data for a route is as explained in the detailed description of FIG. 4B.

FIG. 4B illustrates an exemplary map tile 400b comprising ground truth vehicle traces of the ground truth vehicle for a route 403, in accordance to one or more example embodiments. In various embodiments, the map tile 400b may comprise the plurality of routes. Here for purpose of explanation, the route 403 of the plurality of routes in the map tile 400b is considered. In various embodiments, the route 403 may be the route 301 as exemplarily illustrated in FIG. 3A-3F. To that end, the ground truth data collected on the route 403 may be the ground truth data 300b as exemplarily illustrated in FIG. 3B. When travelling on the route 403, the ground truth vehicle may generate ground truth vehicle traces 405 on the route 403. In various embodiments, the ground truth vehicle traces 405 may indicate locations of the ground truth vehicles on the route 403. As explained previously, the collection of the ground truth data 300b for the route 403 is based on driver's safety and the third-party liability. As the human drivers cannot work restlessly to the ground truth data 300b for the route 403, the ground truth data 300b may be incomplete and uncertain ground truth data. To that end, the ground truth data 300b may not be used to evaluate the sensor data 401. Accordingly, in various embodiments, the system 101 may be configured to process the ground truth data 300b to identify the useful road segment portions (for instance, the useful road segment portions 323 and 325) on the route 403 for evaluating the sensor data 401. Further, the useful road segment portions identified by the system 101 for the route 403 are as explained in the detailed description of FIG. 4C.

FIG. 4C illustrates an exemplary map tile 400c comprising useful road segment portions 407 for the route 403, in accordance to one or more example embodiments. In various embodiments, the system 101 may be configured to identify the useful road segment portions 407 from the ground truth data 300b of the route 403 as explained in the detail description of FIG. 3A-3F. In various embodiments, the useful road segment portions 407 may be the useful road segment portions 323 and 325, when the route 403 and the route 301 are same. Further, in various embodiments, the system 101 may be configured to determine the useful ground truth data based on the useful road segment portions 407 as explained in the detail description of FIG. 3A-3F. Furthermore, the system 101 may compare the sensor data 401 with the useful ground truth data determined in the useful road segment portions 407. To that end, the evaluation process of the sensor data 401 is optimized, as the system 101 may compare the sensor data 401 only with the useful ground truth data determined in the useful road segment portions 407 rather than considering the complete stretch of the route 403 and the ground truth data 300b collected in the route 403. Accordingly, a processing speed of the system 101 may be improved as the evaluation process is optimized. Therefore, the performance or efficiency of the system 101 may be accordingly improved. Further, the useful ground truth data determined in the useful road segment portions 407 is as explained in the detailed description of FIG. 4D.

FIG. 4D illustrates an exemplary map tile 400d comprising useful ground truth data 409 determined in the useful road segment portions 407, in accordance to one or more example embodiments. In various embodiments, the system 101 may determine the useful ground truth data 409 in the useful road segment portions 407 as explained in the detailed description of FIG. 3F. In various embodiments, the useful ground truth data 409 may be the optimized ground truth data. The map tile 400d, the map tile 400c, the map tile 400b and the map tile 400a may be the same, for instance, the map tile of one particular region.

Similarly, the ground truth data for each of the plurality of routes in the map tile 400d may be collected. Further, the system 101 may be configured to identify the useful road segment portion (i.e. the useful road segment portions 407) for each of the plurality of routes in the map tile 400d and determine the useful ground truth data (i.e. the useful ground truth data 409) for each of the plurality of routes in the map tile 400d to evaluate the sensor data 401. To that end, the system 101 may determine at least one the accuracy value, the coverage value or the combination thereof for the sensor data 401 to accurately provide up-to-date navigation functions for the consumer vehicles travelling in the region the covered by the map tile 400a.

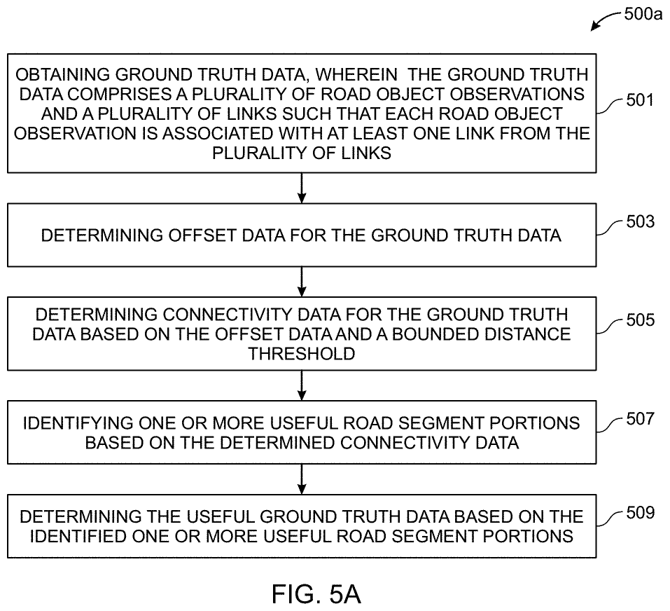

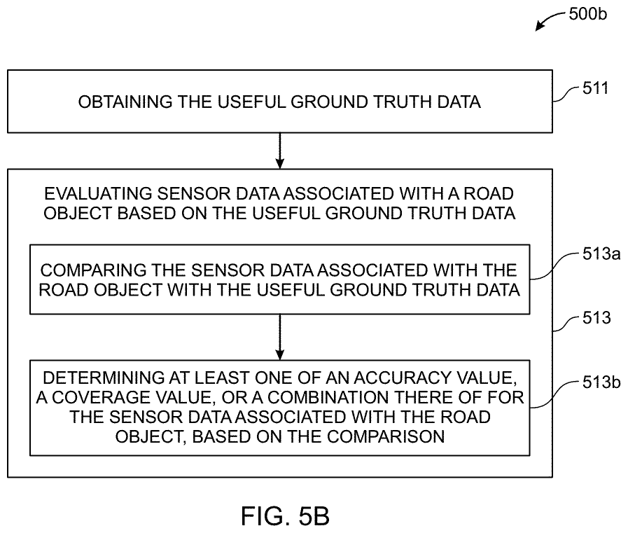

FIG. 5A illustrates a flowchart depicting a method 500a for determining the useful ground truth data, in accordance with one or more example embodiments. It will be understood that each block of the flow diagram of the method 500a may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 500a illustrated in FIG. 5A for determining the useful ground truth data may comprise, at block 501, obtaining the ground truth data 300b, wherein the ground truth data 300b may comprise the plurality of road object observations 305a, 307b, 311b, and 313b and the plurality of links 301-1, 301-2, 301-3, 301-4, 301-5, and 301-6 such that each road object observation (305a, 307b, 311b, and 313b) is associated with at least one link from the plurality of links 301-1, 301-2, 301-3, 301-4, 301-5, and 301-6. For instance, the ground truth data reception module 201a may be configured to obtain the ground truth data 300b as explained in the detailed description of FIG. 3B.

At block 503, the method 500a may comprise determining the offset data 300c for the ground truth data 300b. For instance, the offset data determination module 201b may be configured to determine the offset data 300c for the ground truth data 300b as explained in the detailed description of FIG. 3C. Further, in some embodiments, the method 500a may comprise, at block 503, determining the offset start location and the offset end location associated with each road object observation (305a, 307b, 311b, and 313b) based on the GPS coordinate data associated with the road object observations (305a, 307b, 311b, and 313b). For instance, the offset data determination module 201b may be configured to determine the offset start location and the offset end location associated with each road object observation (305a, 307b, 311b, and 313b) as explained in the detailed description of FIG. 3C.

At block 505, the method 500a may comprise determining the connectivity data 300d for the ground truth data 300b based on the offset data 300c and the bounded distance threshold 315. For instance, the connectivity data determination module 201c may be configured to determine the connectivity data 300d for the ground truth data 300b based on the offset data 300c and the bounded distance threshold 315 as explained in the detailed description of FIG. 3D and FIG. 3E. Further, in some embodiments, the method 500a may comprise, at block 505, extracting the set of connected links from the plurality of links 301-1, 301-2, 301-3, 301-4, 301-5 and 301-6 based on the offset data 300c and the bounded distance threshold 315. For instance, the connectivity data determination module 201c may be configured to extract the set of connected links from the plurality of links 301-1, 301-2, 301-3, 301-4, 301-5 and 301-6 based on the offset data 300c and the bounded distance threshold 315 as explained in the detailed description of FIG. 3D and FIG. 3E. In various embodiments, the distance between any two links in the set of connected links is less than or equal to the bounded distance threshold 315. Furthermore, in some embodiments, the method 500a may comprise, at block 505, determining the timestamp data associated with each road object observation from the plurality of road object observations 305a, 307b, 311b, and 313b; and extracting the set of connected links from the plurality of links 301-1, 301-2, 301-3, 301-4, 301-5 and 301-6 based on the offset data 300c, the bounded distance threshold 315 and the timestamp data. For instance, the connectivity data determination module 201c may be configured to determine the timestamp data associated with each road object observation from the plurality of road object observations 305a, 307b, 311b, and 313b; and extract the set of connected links from the plurality of links 301-1, 301-2, 301-3, 301-4, 301-5 and 301-6 based on the offset data 300c, the bounded distance threshold 315 and the timestamp data as explained in the detailed description of FIG. 3D and FIG. 3E.

At block 507, the method 500a may comprise identifying the one or more useful road segment portions 323 and 325, based on the determined connectivity data 300d. For instance, the useful road segment portions identification module 201d may be configured to identify the one or more useful road segment portions 323 and 325, based on the determined connectivity data 300d as explained in the detailed description of FIG. 3F.

At block 509, the method 500a may comprise determining the useful ground truth data based on the identified one or more useful road segment portions 323 and 325. For instance, the useful ground truth determination module 201e may be configured to determine the useful ground truth data based on the identified one or more useful road segment portions 323 and 325 as explained in the detailed description of FIG. 3F. In various embodiments, the useful ground truth data may comprise the optimized ground truth data 409 collected by one or more ground truth vehicles. Further, in some embodiments, the method 500a may comprise, at block 509, updating the map database 105a based on the useful ground truth data.

In an example embodiment, a system for performing the method 500a of FIG. 5A above may comprise a processor (e.g. the processor 201) configured to perform some or each of the operations (501-509) described above. The processor may, for example, be configured to perform the operations (501-509) by performing hardware implemented logical functions, executing stored instructions, or executing algorithms for performing each of the operations. Alternatively, the system may comprise means for performing each of the operations described above. In this regard, according to an example embodiment, examples of means for performing operations 501-509 may comprise, for example, the processor 201 and/or a device or circuit for executing instructions or executing an algorithm for processing information as described above. Further, the method 500a may include an additional step of evaluating the sensor data associated with the road object (305a, 307a, 309a, 311a, 313a) based on the useful ground truth data as explained in the detailed description of FIG. 5B.

FIG. 5B illustrates a flowchart depicting a method 500b for evaluating the senor data associated with the road objet (305a, 307a, 309a, 311a, 313a), in accordance with one or more example embodiments. The FIG. 5B may be used in conjunction with the system 101 described in the detailed description of FIG. 3A-3F. Starting at block 511, the method 500b may comprise obtaining the useful ground truth data. For instance, the sensor data evaluation module 201f may be configured to obtain the useful ground truth data from the useful ground truth data determination module 201e.

At block 513, the method 500b may comprise evaluating the sensor data associated with the road object (305a, 307a, 309a, 311a, 313a) based on the useful ground truth data. For instance, the sensor data evaluation module 201f may be configured to evaluate the sensor data associated with the road object (305a, 307a, 309a, 311a, 313a) based on the useful ground truth data as explained in the detailed description of FIG. 3F. Further, the block 513 may comprise a block 513a and a block 513b for evaluating the sensor data associated with the road object (305a, 307a, 309a, 311a, 313a) based on the useful ground truth data.

At block 513a, the method 500b may comprise comparing the sensor data associated with the road object (305a, 307a, 309a, 311a, 313a) with the useful ground truth data. For instance, the sensor data evaluation module 201f may be configured to compare the sensor data associated with the road object (305a, 307a, 309a, 311a, 313a) with the useful ground truth data. At block 513b, the method 500b may comprise determining at least one of an accuracy value, a coverage value, or combination thereof for the sensor data associated with the road object (305a, 307a, 309a, 311a, 313a), based on the comparison. For instance, the sensor data evaluation module 201f may be configured to determine the at least one of the accuracy value, the coverage value, or combination thereof for the sensor data associated with the road object (305a, 307a, 309a, 311a, 313a), based on the comparison as explained in the in the detailed description of FIG. 3F.

On implementing the methods 500a and 500b disclosed herein, the system 101 may determine the reliability value for the sensor data associated with the road object (305a, 307a, 309a, 311a, 313a). Further, the system 101 may accurately provide up-to-date navigation functions for the consumer vehicles, when the reliability value of the sensor data is above or equal to a threshold reliability value. Some non-limiting examples of the navigation functions may include providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, an accurate road sign information in ramp links, provision of traffic information/data, provision of lane level traffic information/data, vehicle trajectory determination and/or guidance, route and/or maneuver visualization, and/or the like.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for determining useful ground truth data, the system comprising:
a memory configured to store computer-executable instructions; and
one or more processors configured to execute the instructions to:
obtain ground truth data, wherein the ground truth data comprises a plurality of road object observations and a plurality of links such that each road object observation is associated with at least one link from the plurality of links;
determine offset data for the ground truth data;
determine connectivity data for the ground truth data based on the offset data and a bounded distance threshold;
identify one or more useful road segment portions based on the determined connectivity data; and
determine the useful ground truth data based on the identified one or more useful road segment portions.

2. The system of claim 1, wherein the one or more processors are further configured to execute the instructions to evaluate sensor data associated with a road object based on the useful ground truth data.

3. The system of claim 2, wherein to evaluate the sensor data associated with the road object, the one or more processors are further configured to:
compare the sensor data associated with the road object with the useful ground truth data; and
determine at least one of an accuracy value, a coverage value, or combination thereof for the sensor data associated with the road object, based on the comparison.

4. The system of claim 1, wherein to determine the offset data for the ground truth data, the one or more processors are further configured to determine an offset start location and an offset end location associated with each road object observation based on a GPS coordinate data associated with the road object observation.

5. The system of claim 1, wherein to determine the connectivity data, the one or more processors are further configured to extract a set of connected links from the plurality of links based on the offset data and the bounded distance threshold, wherein a distance between any two links in the set of connected links is less than or equal to the bounded distance threshold.

6. The system of claim 5, wherein to determine the connectivity data, the one or more processors are further configured to:
determine a timestamp data associated with each road object observation from the plurality of road object observations; and
extract the set of connected links from the plurality of links based on the offset data, the bounded distance threshold and the timestamp data.

7. The system of claim 1, wherein the useful ground truth data comprises optimized ground truth data collected by one or more ground truth vehicles.

8. The system of claim 1, wherein the one or more processors are further configured to execute the instructions to update a map database based on the useful ground truth data.

9. A method for determining useful ground truth data, the method comprising:
obtaining ground truth data, wherein the ground truth data comprises a plurality of road object observations and a plurality of links such that each road object observation is associated with at least one link from the plurality of links;
determining offset data for the ground truth data;
determining connectivity data for the ground truth data based on the offset data and a bounded distance threshold;
identifying one or more useful road segment portions based on the determined connectivity data; and
determining the useful ground truth data based on the identified one or more useful road segment portions.

10. The method of claim 9, further comprising evaluating sensor data associated with a road object based on the useful ground truth data.

11. The method of claim 10, wherein evaluating the sensor data associated with the road object further comprises:
comparing the sensor data associated with the road object with the useful ground truth data; and
determining at least one of an accuracy value, a coverage value, or combination thereof for the sensor data associated with the road object, based on the comparison.

12. The method of claim 9, wherein determining the offset data for the ground truth data further comprises determining an offset start location and an offset end location associated with each road object observation based on a GPS coordinate data associated with the road object observation.

13. The method of claim 9, wherein determining the connectivity data further comprises extracting a set of connected links from the plurality of links based on the offset data and the bounded distance threshold, wherein a distance between any two links in the set of connected links is less than or equal to the bounded distance threshold.

14. The method of claim 13, wherein determining the connectivity data further comprises:
determining a timestamp data associated with each road object observation from the plurality of road object observations; and
extracting the set of connected links from the plurality of links based on the offset data, the bounded distance threshold and the timestamp data.

15. The method of claim 9, wherein the useful ground truth data comprises optimized ground truth data collected by one or more ground truth vehicles.

16. The method of claim 9, further comprising updating a map database based on the useful ground truth data.

17. A computer program product comprising a non-transitory computer readable medium having stored thereon computer executable instruction which when executed by one or more processors, cause the one or more processors to carry out operations for determining useful ground truth data, the operations comprising:
obtaining ground truth data, wherein the ground truth data comprises a plurality of road object observations and a plurality of links such that each road object observation is associated with at least one link from the plurality of links;
determining offset data for the ground truth data;
determining connectivity data for the ground truth data based on the offset data and a bounded distance threshold;
identifying one or more useful road segment portions based on the determined connectivity data; and
determining the useful ground truth data based on the identified one or more useful road segment portions.

18. The computer program product of claim 17, wherein the one or more processors are further configured to carry out the operations comprising evaluating sensor data associated with a road object based on the useful ground truth data.

19. The computer program product of claim 17, wherein for determining the connectivity data, the one or more processors are further configured to carry out the operations comprising extracting a set of connected links from the plurality of links based on the offset data and the bounded distance threshold, wherein a distance between any two links in the set of connected links is less than or equal to the bounded distance threshold.

20. The computer program product of claim 19, wherein for determining the connectivity data, the one or more processors are further configured to carry out the operations comprising:
determining a timestamp data associated with each road object observation from the plurality of road object observations; and
extracting the set of connected links from the plurality of links based on the offset data, the bounded distance threshold and the timestamp data.
